(19) United States
(12) Patent Application Publication
(10) Pub. No.: US 2007/0289655 A1
(43) Pub. Date: Dec. 20, 2007

(54) High-strength welded steel pipe

(76) Inventors: Masahiko Hamada, Kobe-shi (JP); Shuji Okaguchi, Nara-shi (JP); Yuichi Komizo, Nishinomiya-shi (JP)

Correspondence Address: CLARK & BRODY, 1090 VERMONT AVENUE, NW, SUITE 250, WASHINGTON, DC, 20005, US

(21) Appl. No.: 11/797,103

(22) Filed: May 1, 2007

Related U.S. Application Data
(63) Continuation of application No. PCT/JP05/19560, filed on Oct. 25, 2005.

(30) Foreign Application Priority Data
Nov. 5, 2004 (JP) 2004-322266

(51) Int. Cl. F16L 9/02

(52) U.S. Cl. 138/171; 138/142

(57) ABSTRACT

A high-strength welded steel pipe having a pipe base metal with a tensile strength of at least 760 MPa and which prevents the occurrence of transverse cracks in weld metal without carrying out preheating or postheating has a seam weld having weld metal with a tensile strength of at least 780 MPa and an average grain diameter of prior austenite in the weld metal of an inner seam weld of at least 90 μm and at most 150 μm. The pipe base metal contains C: 0.02-0.12%, Si: 0.01-0.50%, Mn: 0.4-2.5%, P: at most 0.015%, S: at most 0.003%, Nb: 0.005-0.10%, Al: 0.005-0.06%, and optionally at least one of Cu, Ni, Cr, Mo, V, and B, and the inner seam weld metal contains C: 0.02-0.12%, Si: 0.05-0.50%, Mn: 0.4-2.5%, Cr, Mo, and Ni: 0.1-3.0% each, Ti: 0.005-0.050%, and Al: 0.005-0.050%.

### TECHNICAL FIELD

This invention relates to a high-strength welded steel pipe suitable as line pipe for transporting petroleum, natural gas, and the like.

### BACKGROUND ART

Large-diameter welded steel pipe such as line pipe used to make a pipeline for transporting petroleum, natural gas, and the like is primarily either UOE steel pipe, which is manufactured by a process including the steps of U-forming, O-forming, welding, and expanding, or spiral steel pipe, which is manufactured by forming into a spiral shape and welding. With both types of steel pipes, welding after forming is normally carried out by double-sided (both-side) seam welding. Double-sided seam welding is normally carried out by submerged arc welding or similar welding method in which welding is performed with two steps including inner seam welding by an inner welding machine and subsequent outer seam welding by an outer welding machine.

The transport efficiency of line pipe can be increased and its costs can be decreased by increasing the operating pressure thereof. In order to increase the operating pressure, it is necessary to increase the wall thickness or increase the strength of steel pipe. Increasing the wall thickness of steel pipe is technically easy, but doing so is accompanied by an increase in the weight of the steel pipe and a decrease in the installation efficiency by welding in the field. Accordingly, there is a great need for an increase in the strength of steel pipe. In order to increase the strength of welded steel pipe, it is necessary to increase the strength of the base metal of the steel pipe as well as to increase the strength of the weld metal of a seam weld (also referred below as seam weld metal). However, if the strength of seam weld metal is increased, it becomes easy for transverse cracks to occur in the weld metal at the time of steel pipe manufacture, so there is a need to develop a countermeasure for preventing it.

When welded steel pipes are manufactured from high tensile strength steel with a tensile strength of at least 780 MPa which is known as HT80, it is difficult to prevent transverse cracking in the seam weld metal, and it has become necessary to perform preheating or postheating of welds (Journal of the Japan Welding Society 49 (1980) p. 572). However, since employing preheating or postheating markedly decreases productivity, there has been a desire for the development of a method for carrying out seam welding of high-strength steel pipes without preheating or postheating.

JP 10-306348 A1 discloses a technique for improving crack sensitivity of seam weld metal of a welded steel pipe by increasing the oxygen content of the weld metal. However, increasing the oxygen content of the weld metal decreases the toughness thereof (particularly the absorbed energy at the time of ductile fracture). Accordingly, with this technique, it is difficult to simultaneously achieve a decrease in crack sensitivity and an increase in toughness.

JP 2002-115032 A1 discloses a method of improving crack sensitivity of seam weld metal of a welded steel pipe by allowing the weld metal to contain at least 1% of residual austenitic phase. However, it is difficult to stably maintain at least 1% of residual austenitic phase in the seam weld metal of a welded steel pipe which is used in an as-welded state.

### DISCLOSURE OF INVENTION

The object of this invention is to provide a high-strength welded steel pipe which can prevent the occurrence of transverse cracking in seam weld metal without carrying out preheating or postheating of welds.

The present inventors investigated transverse cracking of seam weld metal in a welded steel pipe with respect to line pipe of API X100 or higher grade (a tensile strength of at least 760 MPa). As a result, it was found that transverse cracks develop in the inner seam weld of seam weld metal or from the inner seam weld to the outer seam weld thereof, and that the occurrence of transverse cracking in the seam weld metal of welded steel pipes cannot be prevented just by increasing the strength of the weld metal, but that it can be prevented by additionally prescribing the grain size of prior austenite, which relates to solidification path of the weld metal of the inner seam weld.

The present invention relates to a high-strength welded steel pipe having a base metal made of a steel having a tensile strength of at least 760 MPa and a seam weld which is formed by inner seam welding and subsequent outer seam welding. A high-strength welded steel pipe according to the present invention is characterized in that weld metal in a seam weld (seam weld metal) has a tensile strength of at least 780 MPa and the weld metal of the inner seam weld formed by inner seam welding has an average grain diameter of prior austenite which is at least 90 μm and at most 150 μm.

Seam welding of a welded steel pipe can be carried out with more than two steps, whereby at least two layers of inner seam welds may be formed. In this case, the present invention is characterized in that the average grain diameter of prior austenite of the innermost layer of the inner seam weld (in other words, the inner seam weld layer adjacent to the outer seam weld) is at least 90 μm and at most 150 μm.

In a steel pipe cross section obtained by cutting the seam weld of a welded steel pipe along the welding direction or a steel pipe cross section obtained by cutting the seam weld in the direction perpendicular to the welding direction, the weld metal of the inner seam weld formed by inner seam welding (referred to below as the inner seam weld metal or inner weld metal) and the weld metal of the outer seam weld formed by outer seam welding (referred to below as the outer seam weld metal or outer weld metal) can be easily distinguished from each other. The tensile strength and other mechanical properties of the inner seam weld metal and the outer seam weld metal can be measured using test pieces of the weld metal taken from the corresponding welds.

In the present invention, “seam weld metal” means the weld metal of the entire seam weld formed by inner seam welding and outer seam welding. The tensile strength of this seam weld metal (the tensile strength of the weld metal of the seam weld) is the lower of the tensile strength of the inner seam weld metal and the tensile strength of the outer seam weld metal. When there are three or more layers of seam weld metal, the lowest value among their tensile strength is the tensile strength of the seam weld metal.

The prior austenite grains can be observed on a test piece under an optical microscope after the test piece has been treated by embedding, polishing, and etching according to a prescribed procedure.

The average grain diameter of prior austenite is measured by observing a cross section of a test piece (which has been treated as described above) obtained by dividing a seam weld in two portions along the welding direction (the axial direction of a steel pipe). Specifically, a measuring line of a given length (L) is drawn in the axial direction of a portion of the inner seam weld metal of this cross section, the number (n) of prior austenite grains through which this measuring line passes is counted, and the value (L/n) of the measured length (L) divided by the number (n) is taken as the average grain diameter of prior austenite. In order to avoid the portion of the inner seam weld metal which may have undergone retransformation due to heat affection at the time of outer seam welding (namely, the portion close to the border with the outer seam weld metal), measurement is carried out in a region of 2-5 mm from the inner side end of the inner seam weld metal.

As long as the tensile strength of the seam weld metal and the average prior austenite grain diameter of the inner seam weld metal satisfy the above-described requirements, there are no particular limitations on the chemical composition of the pipe base metal and that of the weld metal of the seam weld in a high-strength welded steel pipe according to the present invention. However, such a high-strength welded steel pipe can be realized when the base metal and the inner seam weld metal have the below-described respective chemical compositions (in mass percent, with a remainder of Fe and impurities).

Preferred Chemical Composition of Base Metal of Steel Pipe:

C, 0.02-0.12%, Si: 0.01-0.50%, Mn: 0.4-2.5%, P: at most 0.015%, S: at most 0.003%, Nb: 0.005-0.10%, Al: 0.005-0.06%, N: at most 0.006%, 0: at most 0.006%, Cu: 0-3.0%, Ni: 0-3.0%, Cr: 0-3.0%, Mo: 0-3.0%, V: 0-0.10%, B: 0-0.0020%, and Ti: 0-0.02%.

Preferred Chemical Composition of Inner Seam Weld Metal:

C, 0.02-0.12%, Si: 0.05-0.50%, Mn: 0.4-2.5%, P: at most 0.015%, S: at most 0.003%, Cr, Mo, and Ni: 0.1-3.0% each, 0: at most 0.035%, N: at most 0.01%, Ti: 0.005-0.050%, Al: 0.005-0.050%, Cu: 0-1.0%, Nb: 0-0.05%, V: 0-0.05%, Ca: 0-0.01%, Mg: 0-0.01%, Ce: 0-0.01%, and B: 0-0.0040%.

The tensile strength of the pipe base metal and the tensile strength of the seam weld metal are both preferably at least 900 MPa. According to the present invention, transverse cracking of welds can be prevented even when the tensile strength of a pipe base metal and a seam weld metal are at least 900 MPa, namely, even with a high-strength welded steel pipe of at least API X100 grade.

In order to investigate the cause of the occurrence of transverse cracking in the seam weld of a welded steel pipe, the present inventors manufactured large-diameter steel pipes having a total of two layers of seam weld metal by forming a steel plate with a U press and a 0 press and then performing seam welding of a first layer from the inner surface followed by seam welding of another layer from the outer surface by the submerged arc welding method, and they investigated in detail the locations where transverse cracking occurred. Steel plate with a tensile strength of 943 MPa and a plate thickness of 16 mm was used as the pipe base metal, and the outer diameter of the steel pipes was 36 inches (91.4 cm). Various combinations of different welding wires were used as welding materials.

In steel pipes in which transverse cracking occurred, the transverse cracks either existed within the inner weld metal or extended through the inner weld metal and the outer weld metal. There was no observation of any transverse cracks which existed within the outer weld metal which was the second-formed layer. These results suggest that transverse cracks in the weld metal originate in the weld metal of the inner seam weld which undergoes reheating after being welded at the time of outer seam welding, and that there is a possibility that reheat embrittlement of weld metal participates in the development of transverse cracks.

Reheat embrittlement during welding is thought to be caused by segregation of P and S at grain boundaries. Reducing P and S is effective at decreasing the segregation. However, P and S are unavoidable impurity elements contained in steel materials (pipe base metals and welding wires), and there is a limit on how much they can be reduced. Therefore, the present inventors varied the solidification path of weld metal (the pathway of solidification) to investigate whether it is possible to decrease the sensitivity to transverse cracking by a particular solidification path.

The solidification path of weld metal is thought to be influenced by the balance between ferrite-forming elements and austenite-forming elements contained in the weld metal. Thus, when a sample was prepared of a steel pipe having a weld metal in which Ni, which is a typical austenite-forming element, was decreased and Cr and Mo, which are ferrite-forming elements, were increased, it was found that even though the tensile strength of the weld metal was high, transverse cracking of the weld metal did not occur.

The solidification path of weld metal changes as austenite-forming elements increase. When the amount of austenite-forming elements is small, after δ (delta) ferrite precipitates from a liquid phase, solidification occurs from single δ phase. As the amount of austenite-forming elements increases, after δ ferrite precipitates, an austenitic phase is formed by a peritectic reaction before the liquid phase disappears, and solidification is completed through a state in which three phases co-exist. In general, ferrite can dissolve a larger amount of P and S therein than can austenite, so in order to decrease segregation of P and S, it is thought to be desirable that solidification be allowed to occur from single δ phase.

In light of the above consideration, it is conjectured that a difference in sensitivity to transverse cracking is caused by a difference in the state of segregation of P and S resulting from that solidification of single δ phase occurs in a seam weld metal in which transverse cracking is prevented by containing a decreased amount of Ni and an increased amount of Cr and Mo and that a peritectic reaction occurs in a seam weld metal containing an increased amount of Ni and a decreased amount of Co and Mo.

Elements contained in steel can be classified as either austenite-forming elements or ferrite-forming elements. Since the effect thereof differs from one element to another, it is difficult to express the difference in the solidification path as a function of the contents of the elements in steel. Therefore, it was attempted to distinguish weld metal which passed through a peritectic reaction from weld metal which solidified from single δ phase in terms of a micrstructural factor.

Due to its high strength, weld metal which the present invention addresses is characterized by having a microstructure which contains a large amount of phases formed by transformation at low temperatures such as bainite and martensite, thereby making it easy to observe prior austenite grain boundaries. Thus, a seam weld metal was divided in two along the welding direction, and the prior austenite grains of the inner seam weld metal were observed in the resulting cross section. As a result, it was found that the average grain diameter of prior austenite was at least 90 μm in the inner seam weld metal in which transverse cracking did not occur, while it had a smaller value of around 50 μm in the inner seam weld metal in which cracking occurred, indicating that sensitivity to transverse cracking can be evaluated using this average grain diameter as an index.

The relationship between the prior austenite grain diameter and the solidification path is thought to be as follows. If the solidification path is solidification from a single δ phase, δ ferrite precipitates from a liquid phase at high temperatures and grow to form coarse grains, and the resulting coarse δ grains are transformed into γ (gamma), so the grain diameter of prior austenite becomes large. In contrast, when a solidification path includes a peritectic reaction, due to the microstructure refining effect of the peritectic reaction, the prior austenite grains have a decreased diameter. Accordingly, the prior austenite grain diameter serves as an index for determining whether the solidification path is solidification from a single δ ferrite phase or solidification via a peritectic reaction, and using this index, the sensitivity to transverse cracking of an inner seam weld can be determined.

In the prior art, it has not been attempted to clarify the influence of a solidification path on transverse cracks observed in weld metal of high-strength welded pipes. In addition, there is no prior art which relates the difference of a solidification path of rapidly solidified weld metal to changes in the prior austenite grain diameter thereof.

According to the present invention, it becomes possible to stably manufacture welded steel pipes having a high strength of a level such that the tensile strength of the seam weld is at least 780 MPa and preferably at least 900 MPa (for example, a high-strength large-diameter steel pipe of API X100 grade or above) with high productivity without carrying out preheating or postheating.

### BEST MODE FOR CARRYING OUT THE INVENTION

A welded steel pipe according to the present invention is a welded steel pipe which was seam welded by double-sided seam welding, i.e., by inner seam welding followed by outer seam welding. Typical examples of such a welded steel pipe are UOE steel pipe and spiral steel pipe, but a welded steel pipe according to the present invention is not limited thereto. In addition to the UO pressing method, any of known forming methods such as roll bending, press bending, and the like can be used as a forming method prior to pressing. It is also possible to apply the present invention to a welded structural member other than a welded steel pipe. Seam welding of a welded steel pipe according to the present invention is normally carried out with two steps by inner seam welding and outer seam welding, but it is also possible to have 3 or more layers of welds.

The present invention is intended to apply to a welded steel pipe of API X100 grade or above (having a tensile strength of at least 760 MPa). This is because transverse cracking of weld metal does not become a significant problem in welded steel pipes having a strength lower than X100 grade. Therefore, the tensile strength of the base metal of a steel pipe is at least 760 MPa. The tensile strength of the weld metal needs to be greater than the lower limit (759 MPa) of the tensile strength of the pipe base metal, so the tensile strength of the seam weld metal including the inner seam weld metal and the outer seam weld metal is at least 780 MPa. Namely, the lower of the tensile strength of the inner seam weld metal and the tensile strength of the outer seam weld metal is at least 780 MPa.

As stated above, the tensile strength of the pipe base metal and the tensile strength of the seam weld metal are both preferably at least 900 MPa so as to obtain a welded steel pipe with a high strength which exceeds X100 grade. When the tensile strength of seam weld metal reaches such a high strength, it becomes easier for transverse cracking of weld metal to occur.

In a welded steel pipe according to the present invention, the average grain diameter of prior austenite in the inner seam weld metal is at least 90 μm and at most 150 μm. If the average grain diameter of prior austenite fall within this range, even when the tensile strength of the seam weld metal is a high strength of at least 900 MPa, transverse cracking of the weld metal can be prevented with certainty. The reason therefor is thought to be as follows.

As stated above, an average grain diameter of prior austenite in an inner seam weld metal of 90 μm or larger indicates that the solidification path of the weld metal was solidification from single δ phase. In this case, the sensitivity to cracking decreases due to a decrease in grain boundary segregation. In contrast, an average grain diameter of prior austenite in the weld metal of smaller than 90 μm indicates that the solidification path included the above-described peritectic reaction. In this case, grain boundary segregation increases, resulting in an increased sensitivity to transverse cracking. If the average grain diameter of prior austenite in the inner seam weld metal exceeds 150 μm, the prior austenite grains become too large, and the toughness of the weld metal decreases.

The average grain diameter of prior austenite in the inner seam weld metal is preferably at least 100 μm and at most 130 μm.

There is no particular limit on the outer diameter of the welded steel pipe, although the present invention is primarily directed to large-diameter welded steel pipes having an outer diameter of at least 20 inches (50.8 cm). There is also no particular limit on the wall thickness of a steel pipe, but it is suitably around 15-26 mm. In the manufacture of a high-strength welded steel pipe by double-sided seam welding, the welding heat input increases as the plate thickness increases. If the wall thickness of the steel pipe becomes extremely large, the heat input becomes too large, and there is the possibility of it becoming difficult to prevent occurrence of transverse cracking by the present invention. However, even when the wall thickness of the steel pipe exceeds 26 mm, the occurrence of transverse cracks can be prevented while preventing a decrease in the toughness of the weld metal by increasing the average grain diameter of prior austenite in the inner seam weld metal so as to approach the upper limit within the range of at most 150 μm.

In order to obtain a welded steel pipe in which the tensile strength, toughness, and weldability of the pipe base metal and the weld metal are made proper and which has an average grain diameter of prior austenite in the inner seam weld metal in accordance with the present invention, the chemical compositions of the pipe base metal and the inner seam weld metal (a remainder of Fe and impurities) are preferably as follows. In the chemical compositions, all the percents mean mass percent, and Al means acid soluble Al.

[Chemical Composition of the Pipe Base Metal]

C:

0.02-0.12% of C is added in order to ensure strength. When its amount is less than 0.02%, this effect is small. Addition of C in excess of 0.12% has an adverse effect on weldability due to an increased hardness after the steel undergoes martensitic transformation. A preferred C content is 0.04-0.08%.

Si:

0.01-0.50% of Si is added for deoxidation. In an amount of less than 0.01%, it does not have an effect. Addition of Si in excess of 0.50% causes hard phases such as martensite-austenite constituent to form easily. A preferred Si content is 0.05-0.30%.

Mn:

0.4-2.5% of Mn is added to ensure strength and for deoxidation. In an amount of less than 0.4%, it does not give an effect. If Mn is added in excess of 2.5%, the effect on increasing strength saturates, and the steel properties become deteriorated due to a significant center segregation. A preferred Mn content is 0.8-2.0%.

P, S:

These are elements contained as unavoidable impurities, and their content is preferably as low as possible. This is because the cause of reheat embrittlement of weld metal is thought to be grain boundary segregation of P and S. The permissible upper limits are P: 0.015% and S: 0.003%, and preferred upper limits are P: 0.01% and S: 0.002%.

Nb:

0.005-0.10% of Nb is added in order to enhance strength and toughness. In an amount of less than 0.005%, it does not have an effect, while an amount thereof exceeding 0.10% causes the toughness of weld heat-affected zones to decrease. A preferred Nb content is 0.01-0.05%.

Al:

0.005-0.06% of Al is added for deoxidation. If the amount thereof is less than 0.005%, it does not have an effect, while addition of more than 0.06% forms coarse oxides, thereby adversely affecting steel properties.

N:

N is an unavoidable impurity, and its content is preferably as low as possible. Its allowable upper limit is 0.006%, and a preferred N content is at most 0.004%.

O:

O is an unavoidable impurity, and its content is preferably as low as possible. Its permissible upper limit is 0.006%, and a preferred 0 content is at most 0.004%.

In addition to the above, one or more of the following substances may optionally be added.

Cu, Ni, Cr, Mo:

Each of Cu, Ni, Cr, and Mo may be added with an upper limit of 3.0% for improving strength. When added, a preferred added amount of each element is 0.02-3.0%. At least one of these four elements may be added and preferably at least two and particularly preferably all four elements are added. When Cu is added, it is preferably added together with Ni in order to prevent embrittlement.

V:

V may be added in amount of at most 0.10% for improving strength. When it is added, a preferred added amount of V is 0.005-0.10%.

B:

B may be added in an amount of at most 0.0020% for improving strength. When it is added, a preferred added amount of B is 0.0005-0.0020%.

Ti:

Ti may be added in an amount of at most 0.02% for improving toughness. When it is added, a preferred added amount of Ti is 0.005-0.02%. Ti combines with solid solution N thereby enhancing toughness.

[Chemical Composition of the Inner Seam Weld Metal]

C:

0.02-0.12% of C is contained in order to ensure strength. In an amount of less the 0.02%, it does not have an effect. If C is contained in excess of 0.12%, it leads to a marked hardening of the weld metal.

Si:

0.05-0.50% of Si is contained for deoxidation. In an amount of less than 0.05%, it does not have an effect. If Si is contained in excess of 0.50%, it leads to a decrease in toughness due to an increase in hard phases such as martensite-austenite constituent.

Mn:

0.4-2.5% of Mn is contained in order to ensure strength and for deoxidation. In an amount of less than 0.4%, it does not have an effect. On the other hand, if its content exceeds 2.5%, its effect on increasing strength saturates.

P, S:

These are elements contained as unavoidable impurities, and their content is preferably as low as possible. The allowable upper limits are P: 0.015% and S: 0.003%, and preferred upper limits are P: 0.01% and S: 0.002%.

Cr, Mo, Ni:

Cr, Mo, and Ni are each contained in an amount of 0.1-3.0% with the object of adjusting strength and toughness. For each element, they do not have an effect at a content of less than 0.1%. If any of these elements is contained in excess of 3.0%, its effect on increasing strength saturates.

O:

O is an impurity element, and from the standpoint of ensuring toughness, its content is made at most 0.035%. Preferably it is at most 0.030%.

N:

N is an impurity element, so its content is preferably as low as possible. The allowable upper limit on the N content is 0.01%, and preferably it is at most 0.006%.

Ti:

0.005-0.050% of Ti is contained for improving toughness. In an amount of less than 0.005%, it has no effect. If the Ti content exceeds 0.050%, its effect saturates.

Al:

0.005-0.050% of Al is contained for deoxidation. In an amount of less than 0.005%, it has no effect, while if it exceeds 0.050%, its effect saturates.

In addition to the elements constituting a wire used as a welding material, the elements which are added to and contained in a pipe base metal are incorporated into a weld metal due to dilution with the base metal at the time of welding. In addition, impurity elements contained in a flux used at the time of welding may also be incorporated into the weld metal by a metal slag reaction and the like. Therefore, in addition to the above-described elements, an inner seam weld metal may contain elements incorporated therein which are derived from the pipe base metal and flux. The allowable upper limits for typical elements incorporated in an inner seam weld metal are as follows.

Cu: at most 1.0%, Nb, V: at most 0.05% each, Ca, Mg, Ce: at most 0.01% each, B: at most 0.0040%.

If these incorporated elements are contained in an inner seam weld metal in excess of the above-described upper limits, they cause the formation of precipitates, thereby decreasing the ductility and toughness of the inner weld metal.

The chemical composition of a wire for welding is preferably selected so that the resulting inner weld metal has a chemical composition within the above-described ranges taking into consideration the effect of dilution with the base metal at the time of welding, i.e., taking into consideration the chemical composition of the pipe base metal.

Even if the above-described chemical compositions of the pipe base metal and inner seam weld metal are satisfied, if the average grain diameter of prior austenite in the inner seam weld metal is not at least 90 μm, transverse cracking of a high-strength welded steel pipe cannot be prevented with certainty.

### EXAMPLE

Two types of steel plates H1 and H2 having the chemical compositions (in mass percent), plate thickness, and tensile strength shown in Table 1 were prepared by controlled rolling and controlled cooling of slabs which were manufactured by continuous casting. Tempering was not performed. As shown in Table 1, steel plated H1 had a plate thickness of 16 mm and a tensile strength of 941 MPa, and steel plate H2 had a plate thickness of 20 mm and a tensile strength of 825 MPa.

TABLE 1

| Symbol | Plate | Chemical comp. of steel | | | | | | |
|---|---|---|---|---|---|---|---|---|
| for steel | thickness | plate (mass %) (rem: Fe and impurities) | | | | | | |
| plate | (mm) | C | Si | Mn | P | S | Cu | Ni |
| H1 | 16 | 0.06 | 0.08 | 1.55 | 0.006 | 0.0017 | 0.29 | 0.61 |
| H2 (H3) | 20 (28) | 0.06 | 0.18 | 1.84 | 0.005 | 0.0021 | 0.31 | 0.50 |

| Symbol | Plate | Chemical composition of | | | | | | Tensile | Symbol |
|---|---|---|---|---|---|---|---|---|---|
| for steel | thickness | steel plate, contd. (mass %) | | | | | | strength | for steel |
| plate | (mm) | Cr | Mo | V | Nb | Ti | B | (MPa) | plate |
| H1 | 16 | 0.25 | 0.39 | 0.028 | 0.021 | — | 0.0010 | 941 | H1 |
| H2 (H3) | 20 (28) | 0.03 | 0.25 | — | 0.05 | 0.018 | — | 825 (803) | H2 (H3) |

Numbers in ( ) indicate values for steel plate H3

After these steel plates were formed into open pipes by UO press forming (forming by U pressing followed by O pressing), one layer of seam welding was carried out on each of the inner and outer surfaces of the open pipe to prepare a welded steel pipe with an outer diameter of 36 inches (91.4 cm).

Seam welding was carried out by performing initially tack welding of the open pipe by CO₂ gas shielded arc welding and subsequently main welding using an inner welding machine and an outer welding machine in which a first layer of inner welding was conducted from the inner surface side and then a second layer of outer welding was carried out from the outer surface side. The weld metal formed by tack welding did not remain after main welding. In the main welding, neither preheating nor postheating was carried out.

Inner seam welding was carried out by submerged arc welding using three electrodes (DC-AC-AC), and outer seam welding was carried out by submerged arc welding using four electrodes (DC-AC-AC-AC). The welding heat input was as shown in Table 4.

For the wire used as a welding material, solid wires having a diameter of 4 mm and the chemical compositions shown in Table 2 were prepared. These were used by the combinations shown in Table 4 with the electrodes for inner seam welding and outer seam welding, and eight welded steel pipes shown as A-H in Table 4 were prepared.

A highly basic fused flux having the principal constituents shown in Table 3 was prepared as a welding flux. The amount of diffusible hydrogen in the flux was found to be 3.4 ml/100 g (n=average value of 3 samples) by the glycerin method for measurement of diffusible hydrogen of flux according to JIS-Z-3118. The test was performed using a No. 4 test piece and wire 1 shown in Table 2 as a welding wire. Prior to welding, the flux was dried at 250° C. for at least one hour.

Besides, in order to investigate the effect of an increase in heat input due to an increase in plate thickness, steel plate H3 with a plate thickness of 28 mm and having the same chemical composition as steel plate H2 was prepared in the same manner as described above. The tensile strength of steel plate H3 was 803 MPa.

After this steel plate H3 was formed into an open pipe by roll bending, inner and outer seam welding was carried out by the same method as described above, and welded steel pipe I with an outer diameter of 36 inches was prepared. The wire composition and the heat input used for seam welding were as shown in Table 4.

TABLE 2

| Wire | Chemical composition of test wire (mass %) (rem: Fe and impurities) | | | | | | | | | |
|---|---|---|---|---|---|---|---|---|---|---|
| No. | C | Si | Mn | P | S | Cu | Ni | Cr | Mo | Ti |
| 1 | 0.07 | 0.06 | 2.58 | 0.01 | 0.002 | 0.02 | 6.25 | 0.90 | 1.47 | 0.08 |
| 2 | 0.08 | 0.05 | 2.65 | 0.01 | 0.003 | 0.01 | 6.50 | 2.00 | 3.50 | 0.02 |
| 3 | 0.09 | 0.06 | 2.53 | 0.01 | 0.003 | 0.10 | 0.02 | 1.97 | 3.52 | 0.04 |

TABLE 3
Principal chemical constituents of flux (mass %)

| SiO₂ | MnO | CaO | CaF₂ | MgO | Al₂O₃ | TiO₂ | BaO | others |
|---|---|---|---|---|---|---|---|---|
| 20 | 3.5 | 16.5 | 36.5 | 5.5 | 6 | 4 | 3 | 5 |

TABLE 4

| Symbol | Symbol | Steel plate | | | Welding |
|---|---|---|---|---|---|
| for steel | for steel | thickness | Welding | Wire | heat input |
| pipe | plate | (mm) | position | combination | (kJ/mm) |
| A | H1 | 16 | inner | 1-2-2 | 2.5 |
| | | | outer | 1-2-1-2 | 2.5 |
| B | H1 | 16 | inner | 1-3-2 | 2.5 |
| | | | outer | 1-2-1-2 | 2.5 |
| C | H1 | 16 | inner | 3-2-3 | 2.5 |
| | | | outer | 1-2-1-2 | 2.5 |
| D | H1 | 16 | inner | 3-3-3 | 2.5 |
| | | | outer | 1-2-1-2 | 2.5 |
| E | H1 | 16 | inner | 1-1-1 | 2.5 |
| | | | outer | 1-1-1-1 | 2.5 |
| F | H1 | 16 | inner | 3-3-3 | 2.5 |
| | | | outer | 3-3-3-3 | 2.5 |
| G | H2 | 20 | inner | 1-3-2 | 3.0 |
| | | | outer | 1-2-1-1 | 3.0 |
| H | H2 | 20 | inner | 3-2-1 | 3.0 |
| | | | outer | 1-2-1-1 | 3.0 |
| I | H3 | 28 | inner | 3-2-1 | 4.7 |
| | | | outer | 1-2-1-1 | 4.7 |

The results of analysis by emission spectroscopy of the chemical compositions of the seam weld metals of the inner weld and the outer weld of each welded steel pipe which was manufactured are shown in Table 5.

When at least 48 hours had passed after the completion of welding, the seam weld metal of each welded steel pipe was examined for transverse cracks by ultrasonic flaw detection and observation of a cross section.

The tensile strength of the welded steel pipes was measured by taking a rod-shaped test piece with a diameter of 6 mm and a gage length of 30 mm from the seam weld metal of each of the inner weld and the outer weld of each steel pipe and subjecting it to a tensile test at room temperature.

A Charpy impact test was carried out at −30° C. using a No. 4 V-notched Charpy test piece which was taken from the weld metal of each welded steel pipe at the center of the plate thickness so that it has a ratio of the inner weld metal to the outer weld metal of approximately 1:1 and which was prepared by introducing a notch at the center thereof, and the absorbed energy at the time of fracture was measured (n=average of 3 values).

The average grain diameter of prior austenite in the inner seam weld metal of each welded steel pipe was measured by the above-described method.

The results of the above measurement are shown in Table 6.

TABLE 5

| steel | Welding | Chemical composition of inner and outer seam weld metal (mass %) (rem: Fe and impurities) | | | | | | | | | | | | | |
|---|---|---|---|---|---|---|---|---|---|---|---|---|---|---|---|
| pipe | position | C | Si | Mn | P | S | Cu | Ni | Cr | Mo | V | Nb | Ti | B | O |
| A | inner | 0.05 | 0.15 | 1.75 | 0.008 | 0.002 | 0.20 | 2.64 | 0.71 | 1.16 | 0.021 | 0.012 | 0.009 | 0.0012 | 0.029 |
| | outer | 0.05 | 0.16 | 1.76 | 0.008 | 0.003 | 0.19 | 2.73 | 0.69 | 1.11 | 0.020 | 0.011 | 0.011 | 0.0013 | 0.031 |
| B | inner | 0.05 | 0.15 | 1.74 | 0.010 | 0.002 | 0.21 | 1.94 | 0.71 | 1.16 | 0.021 | 0.012 | 0.010 | 0.0013 | 0.030 |
| | outer | 0.05 | 0.16 | 1.76 | 0.009 | 0.002 | 0.19 | 2.69 | 0.69 | 1.11 | 0.020 | 0.011 | 0.010 | 0.0014 | 0.031 |
| C | inner | 0.05 | 0.15 | 1.74 | 0.010 | 0.002 | 0.22 | 1.10 | 0.88 | 1.49 | 0.021 | 0.012 | 0.009 | 0.0013 | 0.032 |
| | outer | 0.05 | 0.16 | 1.76 | 0.009 | 0.002 | 0.19 | 2.65 | 0.70 | 1.13 | 0.020 | 0.011 | 0.010 | 0.0013 | 0.033 |
| D | inner | 0.05 | 0.15 | 1.73 | 0.008 | 0.003 | 0.23 | 0.40 | 0.88 | 1.49 | 0.021 | 0.012 | 0.009 | 0.0012 | 0.031 |
| | outer | 0.05 | 0.16 | 1.76 | 0.008 | 0.002 | 0.19 | 2.62 | 0.70 | 1.13 | 0.020 | 0.011 | 0.011 | 0.0013 | 0.033 |
| E | inner | 0.04 | 0.15 | 1.74 | 0.010 | 0.002 | 0.20 | 2.59 | 0.50 | 0.77 | 0.021 | 0.012 | 0.010 | 0.0014 | 0.030 |
| | outer | 0.04 | 0.16 | 1.75 | 0.010 | 0.003 | 0.19 | 2.69 | 0.51 | 0.79 | 0.020 | 0.011 | 0.011 | 0.0014 | 0.032 |
| F | inner | 0.05 | 0.15 | 1.73 | 0.008 | 0.003 | 0.23 | 0.58 | 0.88 | 1.49 | 0.021 | 0.012 | 0.009 | 0.0012 | 0.031 |
| | outer | 0.05 | 0.16 | 1.73 | 0.010 | 0.003 | 0.23 | 0.58 | 0.91 | 1.55 | 0.020 | 0.011 | 0.009 | 0.0013 | 0.031 |
| G | inner | 0.06 | 0.21 | 1.92 | 0.009 | 0.002 | 0.21 | 1.91 | 0.54 | 1.01 | 0.004 | 0.033 | 0.015 | 0.0004 | 0.028 |
| | outer | 0.05 | 0.21 | 1.93 | 0.008 | 0.002 | 0.20 | 2.60 | 0.46 | 0.91 | 0.005 | 0.032 | 0.016 | 0.0003 | 0.031 |
| H | inner | 0.06 | 0.21 | 1.92 | 0.008 | 0.002 | 0.22 | 1.53 | 0.60 | 1.17 | 0.006 | 0.033 | 0.016 | 0.0003 | 0.030 |
| | outer | 0.05 | 0.21 | 1.93 | 0.008 | 0.002 | 0.20 | 2.59 | 0.46 | 0.90 | 0.007 | 0.032 | 0.015 | 0.0004 | 0.033 |
| I | inner | 0.05 | 0.20 | 1.94 | 0.007 | 0.003 | 0.21 | 1.51 | 0.62 | 1.13 | 0.007 | 0.033 | 0.015 | 0.0003 | 0.031 |
| | outer | 0.05 | 0.21 | 1.93 | 0.008 | 0.002 | 0.22 | 2.60 | 0.45 | 0.91 | 0.006 | 0.031 | 0.016 | 0.0002 | 0.034 |

TABLE 6

| Symbol | Average grain diameter | | Tensile strength of weld | Absorbed energy |
|---|---|---|---|---|
| for steel | of prior austenite in | Transverse | metal of inner and outer | in Charpy test at |
| pipe | inner weld metal (μm) | cracks | seam weld (MPa) | −30° C. (J) |
| A | 45 | present | inner: 995 | 108 |
| | | | outer: 980 | |
| B | 110 | absent | inner: 982 | 102 |
| | | | outer: 998 | |
| C | 105 | absent | inner: 984 | 99 |
| | | | outer: 978 | |
| D | 109 | absent | inner: 994 | 106 |
| | | | outer: 981 | |
| E | 51 | present | inner: 899 | 103 |
| | | | outer: 892 | |
| F | 111 | absent | inner: 990 | 103 |
| | | | outer: 987 | |
| G | 51 | present | inner: 921 | 154 |
| | | | outer: 935 | |
| H | 94 | absent | inner: 961 | 127 |
| | | | outer: 941 | |
| I | 155 | absent | inner: 951 | 67 |
| | | | outer: 927 | |

As shown in Table 6, transverse cracking occurred in the seam weld metal in steel pipes A, E, and G. The transverse cracks remained inside the inner seam weld metal, or they passed from the inner seam weld metal into the outer seam weld metal. In the welded steel pipes in which this transverse cracking occurred, the average grain diameter of prior austenite in the inner seam weld metal was a small value of around 50 μm. Accordingly, it is thought that solidification did not become single δ phase solidification, and grain boundary segregation was promoted, resulting in the occurrence of transverse cracks. Particularly with steel pipe E, the tensile strength of the weld metal markedly decreased and was considerably less than the tensile strength of the pipe base metal.

In contrast, in the remaining steel pipes, even though the tensile strength of the seam weld metal including the inner weld metal and the outer weld metal maintained a high strength of 927-998 MPa, transverse cracks were prevented. In these steel pipes, the average grain diameter of prior austenite in the inner seam weld metal was a large value of at least 90 μm. It is thought that single δ phase solidification occurred, so grain boundary segregation decreased and transverse cracks were prevented.

Even in steel pipe I for which the heat input at the time of welding was a large value of 4.7 J due to a large plate thickness of 28 mm, the average grain diameter of prior austenite in the inner seam weld metal was at least 90 μm, so the occurrence of transverse cracking was prevented. However, in this case, since the average grain diameter of prior austenite was coarsened to 155 μm, a decrease in toughness compared to the other test steel pipes was observed.

1. A high-strength welded steel pipe having a pipe base metal of a steel with a tensile strength of at least 760 MPa and a seam weld formed by inner seam welding and subsequent outer seam welding, characterized in that the tensile strength of the weld metal of the seam weld is at least 780 MPa, and the average grain diameter of prior austenite in the weld metal of the inner seam weld formed by the inner seam welding is at least 90 μm and at most 150 μm.

2. A welded steel pipe as set forth in claim 1 wherein
the pipe base metal has a chemical composition comprising, in mass percent, C, 0.02-0.12%, Si: 0.01-0.50%, Mn: 0.4-2.5%, P: at most 0.015%, S: at most 0.003%, Nb: 0.005-0.10%, Al: 0.005-0.06%, N: at most 0.006%, 0: at most 0.006%, Cu: 0-3.0%, Ni: 0-3.0%, Cr: 0-3.0%, Mo: 0-3.0%, V: 0-0.10%, B: 0-0.0020%, Ti: 0-0.02%, and a remainder of Fe and impurities, and
the weld metal of the inner seam weld has a chemical composition comprising, in mass percent, C, 0.02-0.12%, Si: 0.05-0.50%, Mn: 0.4-2.5%, P: at most 0.015%, S: at most 0.003%, Cr, Mo, and Ni: 0.1-3.0% each, 0: at most 0.035%, N: at most 0.01%, Ti: 0.005-0.050%, Al: 0.005-0.050%, Cu: 0-1.0%, Nb: 0-0.05%, V: 0-0.05, Ca: 0-0.01%, Mg: 0-0.01%, Ce: 0-0.01%, B: 0-0.0040%, and a remainder of Fe and impurities.

3. A welded steel pipe as set forth in claim 2, wherein the chemical composition of the pipe base metal includes at least one element selected from Cu: 0.02-3.0%, Ni: 0.02-3.0%, Cr: 0.02-3.0%, Mo: 0.02-3.0%, V: 0.005-0.10%, B: 0.0005-0.0020%, and Ti: 0.005-0.02%.

4. A welded steel pipe as set forth in claim 1 wherein the pipe base metal and the weld metal of the seam weld each have a tensile strength at of least 900 MPa.

5. A welded steel pipe as set forth in wherein the steel pipe has a wall thickness of 15-26 mm.

6. A welded steel pipe as set forth in claim 2 wherein the pipe base metal and the weld metal of the seam weld each have a tensile strength at of least 900 MPa.

7. A welded steel pipe as set forth in claim 3 wherein the pipe base metal and the weld metal of the seam weld each have a tensile strength at of least 900 MPa.

8. A welded steel pipe as set forth in claim 2 wherein the steel pipe has a wall thickness of 15-26 mm.

9. A welded steel pipe as set forth in claim 3 wherein the steel pipe has a wall thickness of 15-26 mm.

10. A welded steel pipe as set forth in claim 4 wherein the steel pipe has a wall thickness of 15-26 mm.
